(19) United States
(12) Patent Application Publication
(10) Pub. No.: US 2020/0130238 A1
(43) Pub. Date: Apr. 30, 2020

(54) In-Mold Foam Forming Mold and Method for Forming Golf Head Cover

(71) Applicant: KS CHINA CO., LTD., Dongguan (CN)

(72) Inventor: Songlin Zhang, Dongguan (CN)

(21) Appl. No.: 16/726,316

(22) Filed: Dec. 24, 2019

(30) Foreign Application Priority Data
Sep. 30, 2019 (CN) 201910948475.6

(51) Int. Cl. B29C 44/12; B29C 44/10; B29C 44/58; B29C 44/42

(52) U.S. Cl. CPC B29C 44/12; B29C 44/10; B29L 2031/5227; B29C 44/428; B29C 44/58

(57) ABSTRACT

An in-mold foam forming mold includes a bottom die and a top die. The bottom die has a matching cavity. The top die has a top core which matches with the matching cavity and is to be sleeved by the braided shield, and the top core is moved into the matching cavity during the mold closing. The matching cavity has an inner side wall and a barrier rib for blocking foam material in the matching cavity from overflowing from the cavity opening of the matching cavity during an in-mold foaming process, the barrier rib is laterally cooperative with the top core by clearance fit during the mold closing, and a foam molding cavity matching with the foaming shell is defined in the matching cavity. The manufacturing process is simplified, and the quality of the golf head cover is improved.

### RELATED APPLICATIONS

This application claims the benefit of priority to Chinese Patent Applications No. 201910948475.6 filed on Sep. 30, 2019, which is hereby incorporated by reference in its entirety.

### FIELD OF THE INVENTION

The present invention relates to a forming mold, and more particularly to an in-mold foam forming mold for forming a golf head cover, and a method for forming a golf head cover.

### BACKGROUND OF THE INVENTION

As well knows, golf is a health sport that is elegant, casual, and good for both body and mind. It is also a high consumption sport. One of the reasons for its high consumption is that golf clubs which are essential sports equipment for golf are expensive.

To protect the expensive golf clubs, it is common to place the golf clubs in a golf bag. When a golf bag holds multiple golf clubs at the same time, it's inevitable for the golf clubs to collide with each other during transportation, which may damage golf club. Therefore, a golf head cover for protecting the head of each golf club individually was developed accordingly.

At present, for the existing golf head cover made of a braided shield and leather which are fixed together by a sewing process, so that the existing golf head cover has the disadvantage of complicated manufacturing process. In addition, because the braided shield and the leather are fixed together by the sewing process, there are sewing marks at their joint, which makes the surface of the golf head cover be not smooth enough and affects the appearance, also may scratch the golf head.

Therefore, to overcome the above drawbacks, there is an urgent need for an in-mold foam forming mold and a golf head cover molding method to simplify the manufacturing process and improve the quality.

### SUMMARY OF THE INVENTION

One objective of the present invention is to provide an in-mold foam forming mold to simplify the manufacturing process and improve the quality.

Another objective of the present invention is to provide a method for forming a golf head cover to simplify the manufacturing process and improve the quality.

To achieve the above objective, an in-mold foam forming mold for forming a golf head cover, adapted for forming a foaming shell matching with a golf club head on a braided shield, includes:

a bottom die, having a matching cavity with a cavity opening facing upward; and

a top die, cooperated with the bottom die to make mold closing and mold opening, and having a top core which matches with the matching cavity and is to be sleeved by the braided shield, and the top core being moved into the matching cavity during the mold closing;

the matching cavity has an inner side wall protruding toward the top core and a barrier rib for blocking foam material in the matching cavity from overflowing from the cavity opening of the matching cavity during an in-mold foaming process, the barrier rib is laterally cooperative with the top core by clearance fit during the mold closing, and a foam molding cavity matching with the foaming shell is defined in the matching cavity by the barrier rib and the top core after the mold closing.

Preferably, the top core has a protective layer that is soft, and the protective layer is laterally cooperative with the barrier rib by clearance fit or laterally pressed against the barrier rib during the mold closing.

Preferably, the protective layer covers the top core.

Preferably, the bottom die comprises a bottom die base and a bottom die cover cooperating with a top front end of the bottom die, the matching cavity comprises a first matching cavity formed in the bottom die base and a second matching cavity formed in the bottom die cover, the first matching cavity is penetrated a top surface of the bottom die base and extended along a front and rear direction of the bottom die base, the second matching cavity is penetrated a bottom surface and a rear surface of the bottom die cover, and the second matching cavity is connected to a front end of the first matching cavity when the bottom die cover is covered on the bottom die base, and the top core is located in the first matching cavity and the second matching cavity after the mold closing.

Preferably, two barrier ribs are respectively formed at a left side wall and a right side wall of the first matching cavity, and the barrier ribs are extended along the front and rear direction of the bottom die base to the top surface of the bottom die base.

Preferably, a connection area between the barrier rib and the matching cavity is provided with an arc smooth transition structure.

Preferably, the matching cavity has a front end and a rear end, the front end is shorter but bigger than the rear end.

A method for forming a golf head cover includes steps of:

(1) injecting liquid foam material into the matching cavity of the bottom die;

(2) closing the bottom die and the top die, so that the top core is moved into the matching cavity together with the braided shield in the top core;

(3) heating and pressurizing the in-mold foaming mold, so that a foaming shell integrated with the braided shield is formed on the braided shield, thereby forming a golf head cover; and

(4) opening the bottom die and the top die, and removing the golf head cover from the top core;

in the steps (1) to (3), during a foaming process, the foam material flows along a side wall of the matching cavity to the cavity opening, and is blocked and guided by the bather rib to flow back to the foam molding cavity, and air in the matching cavity and mixed in the foam material is discharged from a gap between the barrier rib and the top core.

Preferably, the step (2) comprises firstly moving the top core together with the braided shield into the first matching cavity of the bottom die base, and then covering the bottom die cover at the top front end of the bottom die base and locking the bottom die cover and the bottom die base; and the step (4) comprises firstly opening the top front end of the bottom die base, and then removing the top core together with the golf head cover away from the bottom die base.

A method for forming a golf head cover includes steps of:

(1) closing the bottom die and the top die, so that the top core together with the braided shield in the top core is moved into the matching cavity, and a foam molding cavity is defined in the matching cavity by the top core and the barrier rib;

(2) injecting liquid foam material into the foam molding cavity of the bottom die;

(3) heating and pressurizing the in-mold foaming mold, so that a foaming shell integrated with the braided shield is formed on the braided shield, thereby forming a golf head cover; and

(4) opening the bottom die and the top die, and removing the golf head cover from the top core;

wherein, in the steps (2) to (3), during a foaming process, the foam material flows along a side wall of the matching cavity to the cavity opening, and is blocked and guided by the bather rib to flow back to the foaming molding cavity, and air in the matching cavity and mixed in the foam material is discharged from a gap between the barrier rib and the top core.

In comparison with the prior arts, the inner side wall of the matching cavity has the inner side wall protruding toward the top core and the bather rib for blocking the foam material in the matching cavity from overflowing from the cavity opening of the matching cavity during the in-mold foaming process, the barrier rib is laterally cooperative with the top core by clearance fit during the mold closing, and the foam molding cavity matching with the foaming shell is defined in the matching cavity by the barrier rib and the top core after the mold closing. Therefore, in the process of molding the foaming shell on the braided shield, the foam material flowing along the side wall to the cavity opening of the matching cavity can be blocked by the barrier rib, and then is guided to flow back to the foam molding cavity, to mold the foamed shell integrated with the braided shield in such an in-mold foaming manner, instead of the traditional sewing process between the braided shield and the leather. On one hand, the connection between the foam shell and the braided shield is smooth; on the other hand, the manufacturing process of the golf head cover is simplified. At the same time, the air in the matching cavity and mixed in the foam material is discharged from the gap between the barrier rib and the top core, which prevents the air from remaining in the foamed shell, thereby improving the quality of the golf head cover.

### BRIEF DESCRIPTION OF THE DRAWINGS

The accompanying drawings facilitate an understanding of the various embodiments of this invention. In such drawings:

FIG. 1 is a perspective view of an in-mold foam forming mold during mold closing between the bottom die and the top die according to one embodiment of the present invention;

FIG. 2 is a perspective view of an in-mold foam forming mold during mold opening between the bottom die and the top die according to one embodiment of the present invention;

FIG. 3 is a schematic diagram of FIG. 1 along A-A line;

FIG. 4 is a schematic diagram of FIG. 1 along B-B line;

FIG. 5 is a schematic diagram of the top die of the in-mold foam forming mold after it is cut longitudinally at its central position;

FIG. 6 is a schematic diagram of the in-mold foam forming mold of FIG. 3 when a foaming shell is formed from the in-mold foam forming mold;

FIG. 7 is a perspective view of a golf head cover formed by the in-mold foam forming mold;

FIG. 8 is a flow chart of a method for forming a golf head cover according to a first embodiment of the present invention; and

FIG. 9 is a flow chart of a method for forming a golf head cover according to a second embodiment of the present invention.

### DETAILED DESCRIPTION OF ILLUSTRATED EMBODIMENTS

A distinct and full description of the technical solution of the present invention will follow by combining with the accompanying drawings.

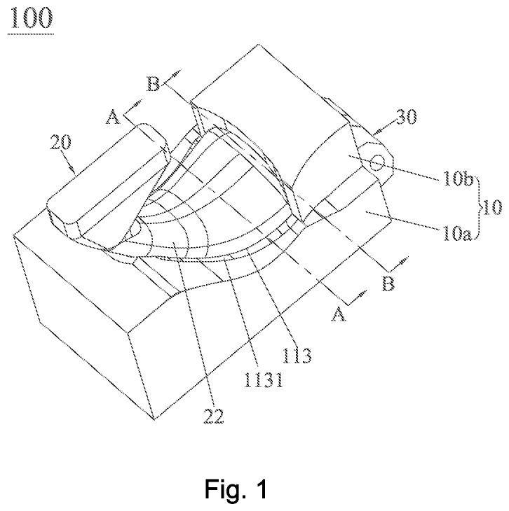

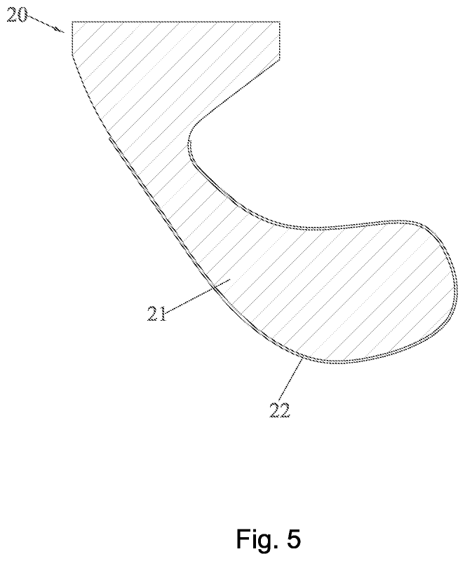

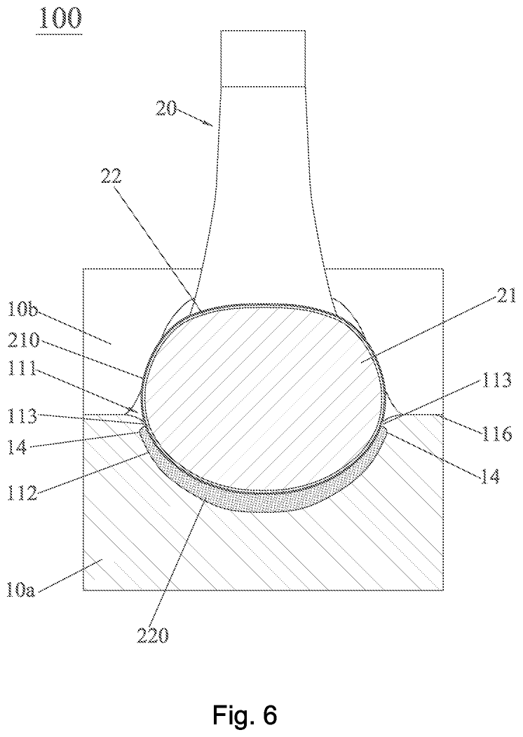

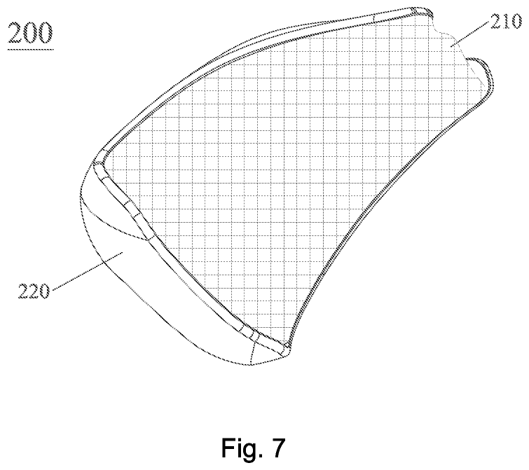

Referring to FIGS. 1-3 and 5-7, an in-mold foam forming mold 100 according to the present invention is adapted for a foaming shell 220 matching with a golf club head on a braided shield 210, so that the foaming shell 220 and the braided shield 210 jointly forms a golf head cover 200, as shown in FIGS. 6 and 7.

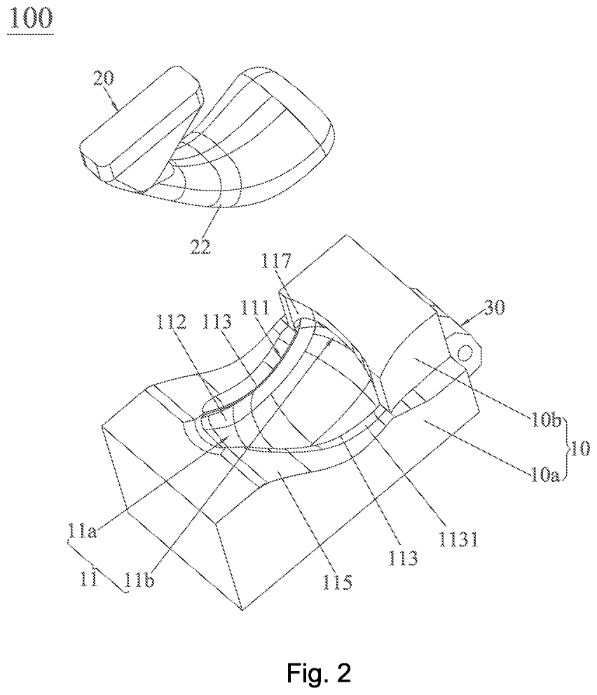

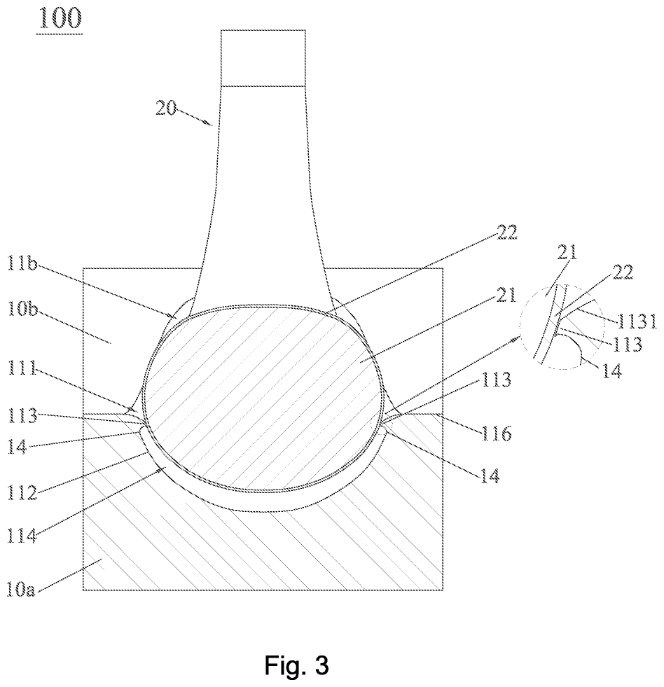

Specifically, the in-mold foam forming mold 100 includes a bottom die 10 and a top die 20 which cooperate with each other for mold closing and opening. The bottom die 10 has a matching cavity 11 with a cavity opening 111 facing upward, and the top die 20 has a top core 21 which cooperates with the matching cavity 11 and is allow to be sleeved by the braided shield 210, so as to benefit the operator to steadily sleeve the braided shield 210 in the top core 21. And the top core 21 is moved into the matching cavity 11 when the mold is closed, as shown In FIGS. 1 and 2. The inner side wall 112 of the matching cavity 11 has an inner side wall protruding toward the top core 21 and a barrier rib 113 for blocking foam material in the matching cavity 11 from overflowing from the cavity opening 111 of the matching cavity 11 during the in-mold foaming process. Preferably, the barrier rib 113 is adjacent to the cavity opening 111, and the upper surface 1131 of the barrier rib 113 is a convex curved surface, so as to ensue the smoothness of the movements of the top core 21 and the braided shield 210. Specifically, the barrier rib 113 is connected with the top core 21 by clearance fit after the mold closing, with a clearance/gap is a suitable space for the braided shield 210 sleeved on the top core 21. In such a way, the braided shield 210 sleeved on the top core 21 can be pressed against the barrier rib 113 laterally after the mold closing, thereby preventing the foam material overflowing from the clearance, and benefiting discharging the air in the matching cavity 11. Meanwhile, with the barrier rib 113 and the top core 21, a foam forming cavity 14 matching with the foaming shell 220 is defined after the mold closing, as shown in FIG. 3.

Specifically, the top core 21 has a protective layer 22 that is soft, preferably, the protective layer 22 covers the top core 21 to enhance the reliability between the protective layer 22 and the top core 21. The protective layer 22 is laterally cooperative with the barrier rib 113 by clearance fit after mold closing (see FIG. 3), which reduces the clearance between the top core 21 and the barrier rib 113, thereby ensuring tight pressing between the braided shield 210 and the barrier rib 113 after mold closing, and further, the foam material is prevented from overflowing from the clearance, but the air in the matching cavity 11 can be discharged normally. Furthermore, since the protective layer 22 is soft, thus braided shield 210 is prevented from being damaged due to the rigid collision between the top core 21 and the bottom die 10 during the mold closing, thereby improving the yield rate of product molding. It can be understood that, because the protective layer 22 is soft, when the protective layer 22 is made to abut against the barrier ribs 113 from the side during the mold closing, the barrier rib 113 may slightly embedded in the protective layer 22 during the mold closing, accordingly, the braided shield 210 may slightly embedded in the protective layer 22 as well due to the adjacency of the barrier rib 113, in such a way, the clearance between the top core 21 and the barrier rib 113 is reduced, and finally, the foam material is prevented from overflowing from the clearance. It is worth noting that when the protective layer 22 is removed (that is, the top core 21 is provided without such a protective layer 22), the braided shield 210 surrounding the top core 21 can also achieve lateral adjacency to the barrier rib 113 when the mold is closed.

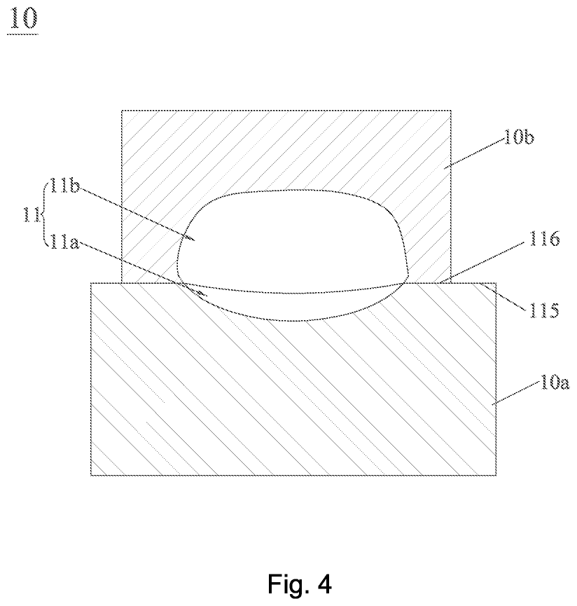

More specifically, as shown in FIGS. 1-4, the bottom die 10 includes a bottom die base 10a and a bottom die cover 10b which cooperates with the top front end of the bottom die base 10a. The matching cavity 11 includes a first matching cavity 11a formed in the bottom die base 10b and a second matching cavity 11b formed in the bottom die cover 10b, the first matching cavity 11a is penetrated a top surface 115 of the bottom die base 10a and extended along a front and rear direction of the bottom die base 10a; the second matching cavity 11b is penetrated a bottom surface 116 and a rear surface 117 of the bottom die cover 10b, and the second matching cavity 11b is connected to a front end of the first matching cavity 11a when the bottom die cover 10b is covered on the bottom die base 10a, and the top core 21 is located in the first matching cavity 11a and the second matching cavity 11b when the mold is closed, as show in FIG. 3. By means of the opening and closing cooperation of the bottom die base 10a and the bottom die cover 10b, the top core 21 can be easily moved into the matching cavity 11 when the mold is closed, and removed from the matching cavity 11 when the mold is opened. Specifically, the bottom die base 10a and the bottom die cover 10b are hinged through a hinge 30, so that the bottom die base 10a and the bottom die cover 10b may cooperate with each other by turning over during the mold closing or opening, by this token the operations of molding closing and opening are more convenient. Preferably, the hinge 30 is located at the front side walls on both sides of the bottom die base 10a and the bottom die cover 10b, which is not limited however.

As shown in FIGS. 2, 3 and 6, two barrier ribs 113 are respectively formed at a left side wall and a right side wall of the first matching cavity 11a, that is, the left side wall and the right side wall of the first matching cavity 11a are provided with a barrier rib 113 respectively. Preferably, the barrier ribs 113 at two side walls are aligned each other, which is dependent on the connection position between the foaming shell 220 and the braided shield 210. Further, the barrier ribs 113 are extended along the front and rear direction of the bottom die base 10a to the top surface 115 of the bottom die base 10a, to further prevent the overflow of the foam material. Specifically, the connection area between the barrier rib 113 and the matching cavity 11 is provided with an arc smooth transition structure that is depressed inward, to make the blocking and the guidance to the foam material more steady and reliable. As an embodiment, the matching cavity has a front end and a rear end, the front end is shorter but bigger than the rear end (as shown in FIG. 2), in order to ensure that the foaming shell 220 with a spherical profile is formed from the braided shield 210 on the top core 21.

It should be noted that before the in-mold foam forming mold 100 of the present invention works, the bottom die 10 needs to be fixed at an external workbench, and the top die 20 is installed at an existing external power mechanism, which is driven by the power mechanism to automatically move close to or away from the bottom die 10 for mold closing and mold opening. While the closing and the opening of the bottom die base 10a and the bottom die cover 10b in the bottom die 10 can be operated manually, or automatically operated by an existing control mechanism, which is not limited here.

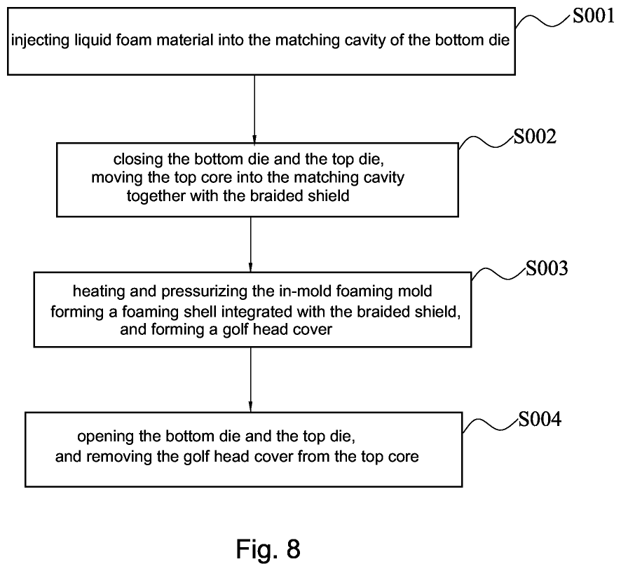

Referring to FIG. 8, a method for forming a golf head cover according to a first embodiment of the present invention includes the following steps.

S001, injecting liquid foam material into the matching cavity 11 of the bottom die 11. Preferably, the foam material can be PU foam material, but it is not limited; it should be noted that the volume of the foam material injected into the matching cavity 11 each time is well known to those skilled in the art, which will not be described for details.

S002, closing the bottom die 10 and the top die 20, so that the top core 21 is moved into the matching cavity 11 together with the braided shield 210 in the top core 21, as shown in FIG. 6. Specifically, in this step, it includes firstly moving the top core 21 together with the braided shield 210 into the first matching cavity 11a of the bottom die base 10a, and then covering the bottom die cover 10b at a top front end of the bottom die base 10a and locking the bottom die cover 10b and the bottom die base 10a.

S003, heating and pressurizing the in-mold foaming mold 100, so that a foaming shell 220 integrated with the braided shield 210 is formed on the braided shield 210 (referring to FIG. 6), thereby forming a golf head cover 200 constituted by the foaming shell 220 and the braided shield 210, as shown in FIG. 7. It should be noted, the parameters of heating and pressurizing are familiar to the persons skilled in this field, which will not be described for details.

S004, opening the bottom die 10 and the top die 20, and removing the golf head cover 200 from the top core 21. So far, the molding of a golf head cover 200 is completed. Specifically, in the step, it includes firstly opening the top front end of the bottom die base 10a, and then removing the top core 21 together with the golf head cover 200 away from the bottom die base 10b.

In the steps S001 to S003, during the foaming process, the foam material flows along the side wall of the matching cavity 11 to the cavity opening 111, and is blocked and guided by the bather rib 113 to flow back to the foam molding cavity 114, and air in the matching cavity 11 and mixed in the foam material is discharged from gap between the barrier rib 113 and the top core 21, so as to prevent the air remaining in the foaming shell 220 of the golf head 200.

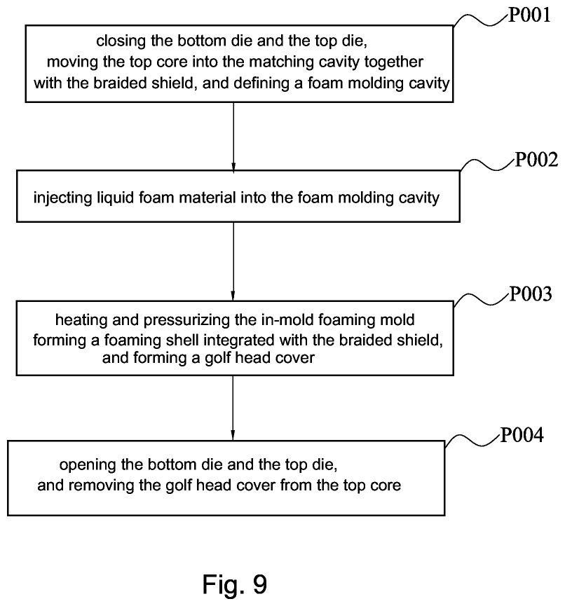

Referring to FIG. 9, a method for forming a golf head cover according to a second embodiment of the present invention includes the following steps.

P001, closing the bottom die 10 and the top die 20, so that the top core 21 together with the braided shield 210 in the top core 21 is moved into the matching cavity 11, and a foam molding cavity 114 is defined in the matching cavity 11 by the top core 21 and the barrier ribs 113. Specifically, this step includes firstly moving the top core 21 together with the braided shield 210 into the first matching cavity 11a of the bottom die base 10a, and then covering the bottom die cover 10b at a top front end of the bottom die base 10a and locking the bottom die cover 10b and the bottom die base 10a.

P002, injecting liquid foam material into the foam molding cavity 114. Preferably, the foam material can be PU foam material, but it is not limited; it should be noted that the volume of the foam material injected into the foam molding cavity 114 each time is well known to those skilled in the art, which will not be described for details. In this embodiment, since the foam molding cavity 114 is injected to the foam molding cavity 114, thus an injection passage can be provided at the bottom die base 10a of the bottom die 10.

P003, heating and pressurizing the in-mold foaming mold 100, so that a foaming shell 220 integrated with the braided shield 210 is formed on the braided shield 210 (referring to FIG. 6), thereby forming a golf head cover 200 constituted by the foaming shell 220 and the braided shield 210, as shown in FIG. 7. It should be noted, the parameters of heating and pressurizing are familiar to the persons skilled in this field, which will not be described for details.

P004, opening the bottom die 10 and the top die 20, and removing the golf head cover 200 from the top core 21. So far, the molding of a golf head cover 200 is completed. Specifically, in the step, it includes firstly opening the top front end of the bottom die base 10a, and then removing the top core 21 together with the golf head cover 200 away from the bottom die base 10b.

In the steps P002 to P003, during the foaming process, the foam material flows along the side wall of the matching cavity 11 to the cavity opening 111, and is blocked and guided by the bather ribs 113 to flow back to the foam molding cavity 114, and air in the matching cavity 11 and mixed in the foam material is discharged from gap between the barrier ribs 113 and the top core 21, so as to prevent the air remaining in the foaming shell 220 of the golf head 200.

Compared with the prior art, the inner side wall 112 of the matching cavity 11 has the inner side wall protruding toward the top core 21 and the barrier rib 113 for blocking the foam material in the matching cavity from overflowing from the cavity opening 111 of the matching cavity 11 during the in-mold foaming process, the barrier rib is laterally cooperative with the top core by clearance fit during the mold closing, and the foam molding cavity 114 matching with the foaming shell is defined in the matching cavity 11 by the barrier rib 113 and the top core 21 after the mold closing. Therefore, in the process of molding the foaming shell 220 on the braided shield 210, the foam material flowing along the side wall 112 to the cavity opening 111 of the matching cavity 11 can be blocked by the barrier rib 113, and then is guided to flow back to the foam molding cavity 114, to mold the foamed shell 220 integrated with the braided shield 210 in such an in-mold foaming manner, instead of the traditional sewing process between the braided shield and the leather. On one hand, the connection between the foam shell 220 and the braided shield 210 is smooth; on the other hand, the manufacturing process of the golf head cover 200 is simplified. At the same time, the air in the matching cavity 11 and mixed in the foam material is discharged from the gap between the barrier rib 113 and the top core 21, which prevents the air from remaining in the foamed shell 220, thereby improving the quality of the golf head cover.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. An in-mold foam forming mold for forming a golf head cover, adapted for forming a foaming shell matching with a golf club head on a braided shield, and the in-mold foam forming mold comprising:
a bottom die, having a matching cavity with a cavity opening facing upward; and
a top die, cooperated with the bottom die to make mold closing and mold opening, and having a top core which matches with the matching cavity and is to be sleeved by the braided shield, and the top core being moved into the matching cavity during the mold closing;
wherein the matching cavity has an inner side wall protruding toward the top core and a barrier rib for blocking foam material in the matching cavity from overflowing from the cavity opening of the matching cavity during an in-mold foaming process, the barrier rib is laterally cooperative with the top core by clearance fit during the mold closing, and a foam molding cavity matching with the foaming shell is defined in the matching cavity by the barrier rib and the top core after the mold closing.

2. The in-mold foam forming mold according to claim 1, wherein the top core has a protective layer that is soft, and the protective layer is laterally cooperative with the barrier rib by clearance fit or laterally pressed against the barrier rib during the mold closing.

3. The in-mold foam forming mold according to claim 2, wherein the protective layer covers the top core.

4. The in-mold foam forming mold according to claim 1, wherein the bottom die comprises a bottom die base and a bottom die cover cooperating with a top front end of the bottom die, the matching cavity comprises a first matching cavity formed in the bottom die base and a second matching cavity formed in the bottom die cover, the first matching cavity is penetrated a top surface of the bottom die base and extended along a front and rear direction of the bottom die base, the second matching cavity is penetrated a bottom surface and a rear surface of the bottom die cover, and the second matching cavity is connected to a front end of the first matching cavity when the bottom die cover is covered on the bottom die base, and the top core is located in the first matching cavity and the second matching cavity after the mold closing.

5. The in-mold foam forming mold according to claim 4, wherein two barrier ribs are respectively formed at a left side wall and a right side wall of the first matching cavity, and the barrier ribs are extended along the front and rear direction of the bottom die base to the top surface of the bottom die base.

6. The in-mold foam forming mold according to claim 1, wherein a connection area between the barrier rib and the matching cavity is provided with an arc smooth transition structure.

7. The in-mold foam forming mold according to claim 1, wherein the matching cavity has a front end and a rear end, the front end is shorter but bigger than the rear end.

8. A method for forming a golf head cover according to claim 4, comprising steps of:
(1) injecting liquid foam material into the matching cavity of the bottom die;
(2) closing the bottom die and the top die, so that the top core is moved into the matching cavity together with the braided shield in the top core;
(3) heating and pressurizing the in-mold foaming mold, so that a foaming shell integrated with the braided shield is formed on the braided shield, thereby forming a golf head cover; and
(4) opening the bottom die and the top die, and removing the golf head cover from the top core;
wherein, in the steps (1) to (3), during a foaming process, the foam material flows along a side wall of the matching cavity to the cavity opening, and is blocked and guided by the barrier rib to flow back to the foam molding cavity, and air in the matching cavity and mixed in the foam material is discharged from a gap between the barrier rib and the top core.

9. The method for forming a golf head cover according to claim 8, wherein the step (2) comprises firstly moving the top core together with the braided shield into the first matching cavity of the bottom die base, and then covering the bottom die cover at the top front end of the bottom die base and locking the bottom die cover and the bottom die base; and the step (4) comprises firstly opening the top front end of the bottom die base, and then removing the top core together with the golf head cover away from the bottom die base.

10. A method for forming a golf head cover according to claim 4, comprising steps of:
(1) closing the bottom die and the top die, so that the top core together with the braided shield in the top core is moved into the matching cavity, and a foam molding cavity is defined in the matching cavity by the top core and the barrier rib;
(2) injecting liquid foam material into the foam molding cavity of the bottom die;
(3) heating and pressurizing the in-mold foaming mold, so that a foaming shell integrated with the braided shield is formed on the braided shield, thereby forming a golf head cover; and
(4) opening the bottom die and the top die, and removing the golf head cover from the top core;
wherein, in the steps (2) to (3), during a foaming process, the foam material flows along a side wall of the matching cavity to the cavity opening, and is blocked and guided by the bather rib to flow back to the foaming molding cavity, and air in the matching cavity and mixed in the foam material is discharged from a gap between the barrier rib and the top core.
